(19) United States
(12) Patent Application Publication
(10) Pub. No.: US 2025/0210884 A1
(43) Pub. Date: Jun. 26, 2025

(54) ACCESS POINT WITH MULTIPLE ANTENNA ARRAYS

(71) Applicant: Cisco Technology, Inc., San Jose, CA (US)

(72) Inventors: Jonathan M. CYPHERT, Richfield, OH (US); Navid POURRAMZANGANDJI, Copley, OH (US); Danielle N. BANE, Cleveland, OH (US); Fred J. ANDERSON, Lakeville, OH (US)

(21) Appl. No.: 18/395,426

(22) Filed: Dec. 22, 2023

(51) Int. Cl. H01Q 21/28; H01Q 3/44

(52) U.S. Cl. CPC H01Q 21/28; H01Q 3/44

(57) ABSTRACT

The present disclosure describes an access point with multiple antenna arrays. The access point includes a first antenna array and a second antenna array. The first antenna array includes a plurality of magnetic antennas. The second antenna array includes a plurality of electrical antennas. Each magnetic antenna of the plurality of magnetic antennas is positioned within four centimeters of a respective electrical antenna of the plurality of electrical antennas.

### TECHNICAL FIELD

Embodiments presented in this disclosure generally relate to network access points. More specifically, embodiments disclosed herein relate to an access point with multiple antenna arrays.

### BACKGROUND

Access points provide devices wireless access to networks. Some access points include multiple radios or antenna arrays.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system.

FIG. 2 illustrates an example access point in the system of FIG. 1.

FIG. 3 illustrates an example access point in the system of FIG. 1.

FIG. 4 illustrates an example access point in the system of FIG. 1.

FIG. 5 is a flowchart of an example method performed in the system of FIG. 1.

FIG. 6 is a flowchart of an example method performed in the system of FIG. 1.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes an access point with multiple antenna arrays. According to an embodiment, an access point includes a first antenna array and a second antenna array. The first antenna array includes a plurality of magnetic antennas. The second antenna array includes a plurality of electrical antennas. Each magnetic antenna of the plurality of magnetic antennas is positioned within four centimeters of a respective electrical antenna of the plurality of electrical antennas.

According to another embodiment, a method includes operating a first antenna array of an access point. The first antenna array includes a plurality of magnetic antennas. The method also includes, while operating the first antenna array, operating a second antenna array of the access point. The second antenna array includes a plurality of electrical antennas. Each magnetic antenna of the plurality of magnetic antennas is positioned within four centimeters of a respective electrical antenna of the plurality of electrical antennas.

According to another embodiment, a system includes a first magnetic loop antenna, a first electric dipole antenna, a second magnetic loop antenna, and a second electric dipole antenna. The first and second magnetic loop antennas and the first and second electric dipole antennas are arranged to operate simultaneously in at least one of a 5 gigaHertz band or a 6 gigaHertz band while providing at least 35 decibels of isolation between the first and second magnetic loop antennas and the first and second electric dipole antennas.

### EXAMPLE EMBODIMENTS

Access points provide devices wireless access to networks. Some access points include multiple radios or antenna arrays. When these radios or antenna arrays are operated concurrently over the same frequency band (e.g., the 5 gigaHertz (GHz) band or the 6 GHz band), the different radios or antenna arrays may interfere with each other, which degrades performance. Conventional access points may use omnidirectional antennas in the radios or antenna arrays, but this may limit the gain provided by the access points. Some conventional access points may cross polarize the radios or antenna arrays, which may allow the transmit power to be increased. But the increase in transmit power may make it more difficult to maintain the needed isolation between the radios or antenna arrays.

The present disclosure describes an access point that uses radios or antenna arrays with different types of antennas. For example, the access point may include an antenna array that uses magnetic loop antennas and another antenna array that uses electric dipole antennas. These antenna arrays may be positioned close to each other (e.g., within 4 centimeters of each other) and may operate in the same frequency band while maintaining an acceptable level of isolation between the antenna arrays (e.g., more than 35 dB of isolation). As a result, the access point may operate concurrent 5 GHz or 6 GHz radios.

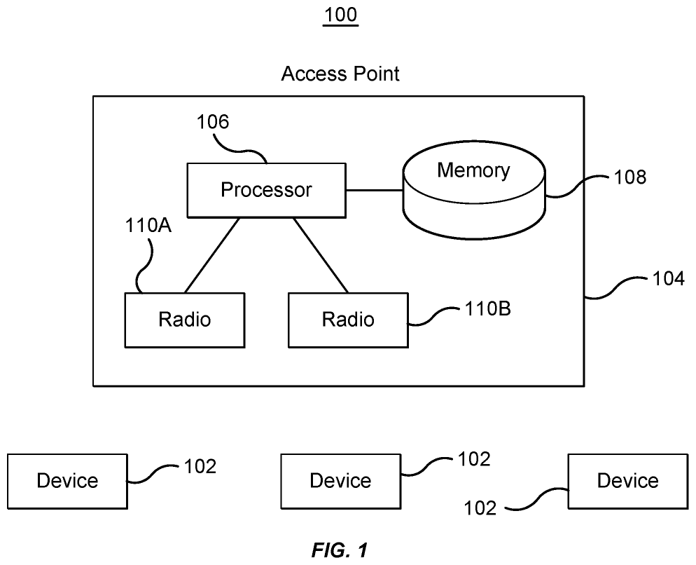

FIG. 1 illustrates an example system 100. As seen in FIG. 1, the system 100 includes one or more devices 102 and an access point 104. Generally, the devices 102 connect to the access point 104. The access point 104 provides network coverage for the system 100. The access point 104 communicates messages to the devices 102 and directs messages from the devices 102 towards their destination.

The device 102 may be any suitable device that wirelessly connects to the access point 104. As an example and not by way of limitation, the device 102 may be a computer, a laptop, a wireless or cellular telephone, an electronic notebook, a personal digital assistant, a tablet, or any other device capable of receiving, processing, storing, or communicating information with other components of the system 100. The device 102 may be a wearable device such as a virtual reality or augmented reality headset, a smart watch, or smart glasses. The device 102 may also include a user interface, such as a display, a microphone, keypad, or other appropriate terminal equipment usable by the user. The device 102 may include a hardware processor, memory, or circuitry configured to perform any of the functions or actions of the device 102 described herein. For example, a software application designed using software code may be stored in the memory and executed by the processor to perform the functions of the device 102.

The access point 104 facilitates wireless communication in the system 100. One or more devices 102 may connect to the access point 104. The access point 104 may then facilitate wireless communication for the connected devices 102. For example, the access point 104 may transmit messages to a connected device 102. As another example, the access point 104 may receive messages transmitted by the device 102. The access point 104 may then direct that message towards its intended destination. As seen in FIG. 1, the access point 104 includes a processor 106, a memory 108, and multiple radios 110 (e.g., radios 110A and 110B). In certain embodiments, the access point 104 operates different types of radios 110 (e.g., a radio with magnetic antennas and another radio with electrical antennas) concurrently over the same frequency band (e.g., the 5 GHz band or the 6 GHz band) while providing at least 35 dB of isolation between the radios. Because the access point 104 uses the different types of radios, these radios may be positioned closer together (e.g., within 4 centimeters of each other) than the radios in conventional access points.

The processor 106 is any electronic circuitry, including, but not limited to one or a combination of microprocessors, microcontrollers, application specific integrated circuits (ASIC), application specific instruction set processor (ASIP), and/or state machines, that communicatively couples to the memory 108 and controls the operation of the access point 104. The processor 106 may be 8-bit, 16-bit, 32-bit, 64-bit or of any other suitable architecture. The processor 106 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 106 may include other hardware that operates software to control and process information. The processor 106 executes software stored on the memory 108 to perform any of the functions described herein. The processor 106 controls the operation and administration of the access point 104 by processing information (e.g., information received from the devices 102, memory 108, and radios 110). The processor 106 is not limited to a single processing device and may encompass multiple processing devices contained in the same device or computer or distributed across multiple devices or computers. The processor 106 is considered to perform a set of functions or actions if the multiple processing devices collectively perform the set of functions or actions, even if different processing devices perform different functions or actions in the set.

The memory 108 may store, either permanently or temporarily, data, operational software, or other information for the processor 106. The memory 108 may include any one or a combination of volatile or non-volatile local or remote devices suitable for storing information. For example, the memory 108 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 108, a disk, a CD, or a flash drive. In particular embodiments, the software may include an application executable by the processor 106 to perform one or more of the functions described herein. The memory 108 is not limited to a single memory and may encompass multiple memories contained in the same device or computer or distributed across multiple devices or computers. The memory 108 is considered to store a set of data, operational software, or information if the multiple memories collectively store the set of data, operational software, or information, even if different memories store different portions of the data, operational software, or information in the set.

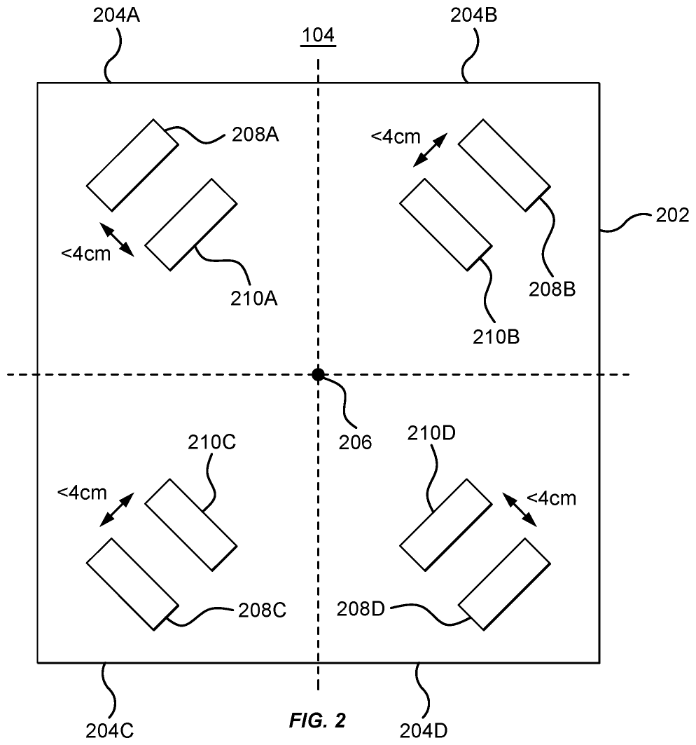

FIG. 2 illustrates an example access point 104 in the system 100 of FIG. 1. As seen in FIG. 2, the access point 104 includes a plate 202 onto which other components of the access point 104 may be positioned. The plate 202 may include any materials (e.g., plastic, metal, wood, etc.) and may be any shape (e.g., circular, rectangular, triangular, etc.). In some embodiments, the plate 202 is formed using a printed circuit board. The plate 202 may include quadrants 204A, 204B, 204C, and 204D. These quadrants 204A, 204B, 204C, and 204D may meet at a center 206 of the plate 202. Different components of the access point 104 may be positioned in the quadrants 204A, 204B, 204C, and 204D.

Antennas of multiple radios may be positioned on the plate 202. In the example of FIG. 2 the antennas 208A, 208B, 208C, and 208D are positioned on the plate 202. The antennas 208A, 208B, 208C, and 208D may be any size or shape. The antenna 208A is positioned in the quadrant 204A. The antenna 208B is positioned in the quadrant 204B. The antenna 208C is positioned in the quadrant 204C. The antenna 208D is positioned in the quadrant 204D. The antennas 208A, 208B, 208C, and 208D may form a radio in the access point 104 (e.g., the radio 110A). The antennas 208A, 208B, 208C, and 208D may be electrical antennas (e.g., electrical dipole antennas) or magnetic antennas (e.g., magnetic loop antennas). The electrical antennas may transmit and receive signals by using primarily the electrical components of their electromagnetic fields. The magnetic antennas may transmit and receive signals by using primarily the magnetic components of their electromagnetic fields. As a result, for electrical antennas, the electrical components of their electromagnetic fields are dominant over the magnetic components of their electromagnetic fields. For magnetic antennas, the magnetic components of their electromagnetic fields are dominant over the electrical components of their electromagnetic fields.

Antennas 210A, 210B, 210C, and 210D are positioned on the plate 202. The antenna 210A is positioned in the quadrant 204A. The antenna 210B is positioned in the quadrant 204B. The antenna 210C is positioned in the quadrant 204C. The antenna 210D is positioned in the quadrant 204D. The antennas 210A, 210B, 210C, and 210D may form a second radio in the access point 104 (e.g., the radio 110B). The antennas 210A, 210B, 210C, and 210D are positioned closer to the center 206 of the plate 202 than the antennas 208A, 208B, 208C and 208D. Additionally, the antennas 210A, 210B, 210C, and 210D may be of a different type than the antennas 208A, 208B, 208C, and 208D. For example, if the antennas 208A, 208B, 208C, and 208D are electrical antennas (e.g., electric dipole antennas), then the antennas 210A, 210B, 210C, and 210D may be magnetic antennas (e.g., magnetic loop antennas). If the antennas 208A, 208B, 208C, and 208D are magnetic antennas, then the antennas 210A, 210B, 210C, and 210D may be electrical antennas.

The antennas 208A, 208B, 208C, 208D, 210A, 210B, 210C, and 210D may be positioned with any orientation on the plate 202 that provides a sufficient amount of isolation between the antennas 208A, 208B, 208C, 208D, 210A, 210B, 210C, and 210D (e.g., 35 dB of isolation). In the example of FIG. 2, the antennas 208A, 208B, 208C, 208D, 210A, 210B, 210C, and 210D are positioned at 45 degree angles relative to the sides of the plate 202. Generally, for two rectangular antennas, the amount of isolation achieved between the antennas may be increased without further separating the antennas by aligning the long edges of the antennas or the short edges of the antennas. For example, as seen in FIG. 2, the long edges of the antennas 208A and 210 A are aligned with each other, and the short edges of the antennas 208A and 210A are aligned with each other. This arrangement may provide a greater amount of isolation between the antennas 208A and 210A relative to an arrangement in which the antenna 210A is rotated ninety degrees from the arrangement shown in FIG. 2 (such that the long edges of the antenna 210A are positioned orthogonal to the long edges of the antenna 208A). The same arrangement is used for the antennas 208B and 210B, 208C and 210C, and 208D and 210D.

Because the antennas 208A, 208B, 208C, and 208D are a different type than the antennas 210A, 210B, 210C, and 210D, the antennas 208A, 208B, 208C, and 208D may be positioned near the antennas 210A, 210B, 210C, and 210D while maintaining a sufficient amount of isolation (e.g., at least 35 dB of isolation) between the antennas 208A, 208B, 208C, and 208D and the antennas 210A, 210B, 210C, and 210D. In the example of FIG. 2, the antennas 208A, 208B, 208C, and 208D are each positioned within four centimeters of the antennas 210A, 210B, 210C, and 210D. The antenna 208A is positioned within four centimeters of the antenna 210A. The antenna 208B is positioned within four centimeters of the antenna 210B. The antenna 208C is positioned within four centimeters of the antenna 210. The antenna 208D is positioned within four centimeters of the antenna 210D. By using different types of antennas for the radios in the access point 104, the access point 104 may operate the radios concurrently in the same frequency band (e.g., 5 GHz band or the 6 GHz band) while maintaining a sufficient amount of isolation (e.g., at least 35 dB of isolation) between the radios.

In one embodiment, the antennas 208A, 208B, 208C, and 208D are dual-band magnetic loop antennas that may operate in the 5 GHz band or the 6 GHz band. The antennas 208A, 208B, 208C, and 208D have a gain of 8 dBi and a beamwidth of 60 degrees×60 degrees in the 5 GHz band and 50 degrees×60 degrees in the 6 GHZ band. The antennas 210A, 210B, 210C, and 210D are tri-band electric dipole antennas that may operate in the 2.4 GHz band, the 5 GHz band, or the 6 GHz band (e.g., as described in the IEEE 802.11 standard). The antennas 210A, 210B, 210C, and 210D have a gain of 8 dBi and a beamwidth of 60 degrees×60 degrees. Each of the antennas 208A, 208B, 208C, 208D, 210A, 210B, 210C, and 210D may be connected to a cable that is attached to the plate 202 and routed to a radio port on the access point 104. Additionally, the antennas 208A, 208B, 208C, 208D may be cross polarized with the antennas 210A, 210B, 210C, and 210D.

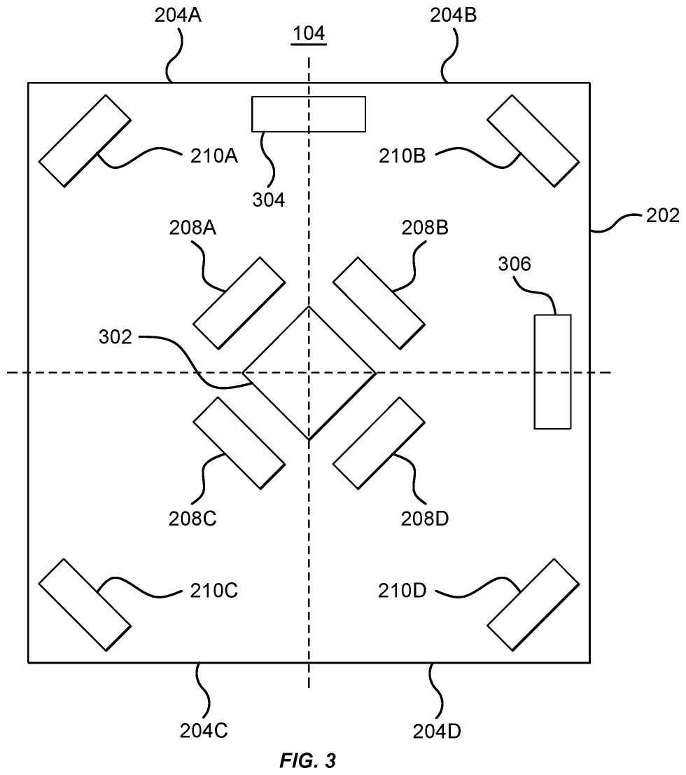

FIG. 3 illustrates an example access point 104 in the system 100 of FIG. 1. As seen in FIG. 3, the access point 104 includes the plate 202. The plate 202 includes the quadrants 204A, 204B, 204C, and 204D. Additionally, the antennas 208A, 208B, 208C, 208D, 210A, 210B, 210C, and 210D are positioned on the plate 202. The antennas 208A and 210A are positioned in the quadrant 204A. The antennas 208B and 210B are positioned in the quadrant 204B. The antennas 208C and 210C are positioned in the quadrant 204C. The antennas 208D and 210D are positioned in the quadrant 204D. Similar to previous examples, the antennas 208A, 208B, 208C, and 208D may be of a different type than the antennas 210A, 210B, 210C, and 210D. For example, the antennas 208A, 208B, 208C, and 208D may be magnetic loop antennas, while the antennas 210A, 210B, 210C, and 210D are electric dipole antennas, and vice versa.

Because the antennas 208A, 208B, 208C, and 208D are of a different type than the antennas 210A, 210B, 210C, and 210D, the antennas 208A, 208B, 208C, and 208D may be positioned close to (e.g., within four centimeters) of the antennas 210A, 210B, 210C, and 210D while maintaining a sufficient amount of isolation (e.g., at least 35 dB of isolation) between the antennas 208A, 208B, 208C, and 208D and the antennas 210A, 210B, 210C, and 210D. As a result, the access point 104 may operate the antennas 208A, 208B, 208C, 208D and the antennas 210A, 210B, 210C, and 210D concurrently using the same frequency bands (e.g., the 5 GHz band or the 6 GHZ band). In the example of FIG. 3, the antenna 208A is positioned within four centimeters of the antenna 210A. The antenna 208B is positioned within four centimeters of the antenna 210B. The antenna 208C is positioned within four centimeters of the antenna 210C. The antenna 208D is positioned within four centimeters of the antenna 208D.

The access point 104 may also include antennas 302, 304, and 306 positioned on the plate 202. The antenna 302 may be positioned at the center of the plate 202 and may be a magnetic antenna (e.g., a magnetic loop antenna). The antennas 208A, 208B, 208C, and 208D are positioned around the antenna 302. In some embodiments, the antenna 302 may be dedicated to communicating with internet of things (IoT) devices. For example, the antenna 302 may transmit and receive messages from IoT devices to free up the antennas 208A, 208B, 208C, 208D, 210A, 210B, 210C, and 210D from needing to communicate with the IoT devices.

The antennas 304 and 306 may be positioned near the edge of the plate 202 and may be an electrical antenna (e.g., an electric dipole antenna). In the example of FIG. 3, the antenna 304 is positioned between the antennas 210A and 210B, and the antenna 306 is positioned between the antennas 210B and 210D. In some embodiments, the antennas 304 and 306 may form a scan radio of the access point 104. The scan radio may detect the performance of other antennas in the access point 104 or antennas of other devices near the access point 104. The access point 104 may then adjust the operation of the antennas 208A, 208B, 208C, 208D, 210A, 210B, 210C, and 210D based on the output from the scan radio.

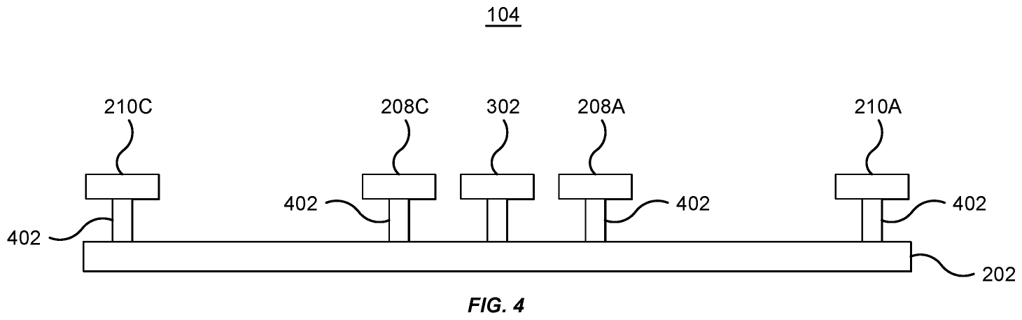

FIG. 4 illustrates an example access point 104 in the system 100 of FIG. 1. Generally, FIG. 4 shows a side view of the access point 104. As seen in FIG. 4, the access point 104 includes the plate 202 onto which other components of the access point 104 may be attached or positioned.

Various antennas are arranged on the plate 202. The antennas 210A and 210C are positioned on opposite ends of the plate 202. The antennas 208A and 208C are positioned closer to the middle of the plate 202 than the antennas 210A and 210C. Additionally, the antenna 302 is positioned closer to the center of the plate 202 than the antennas 208A and 208C. The antennas 210A, 210C, 208A, 208C, and 302 may be attached to the plate 202 by pillars 402. The pillars 402 may be support structures that couple to the plate 202. The pillars 402 may be made of any material (e.g., plastic, wood, metal, nylon, etc.). The pillars 402 may include a screw and a spacer. The screw may screw or couple into the plate 202. As a result, the antennas 210A, 210C, 208A, 208C, and 302 may be elevated off the surface of the plate 202 by the pillars 402. Other antennas of the access point 104 not shown in FIG. 4 may also be attached to and elevated off the plate 202 using other pillars 402. In certain embodiments, the antennas 208A, 208B, 208C, 208D, 210A, 210B, 210C, and 210D are elevated 10 to 20 millimeters off the plate 202 (e.g., 15 millimeters off the plate 202).

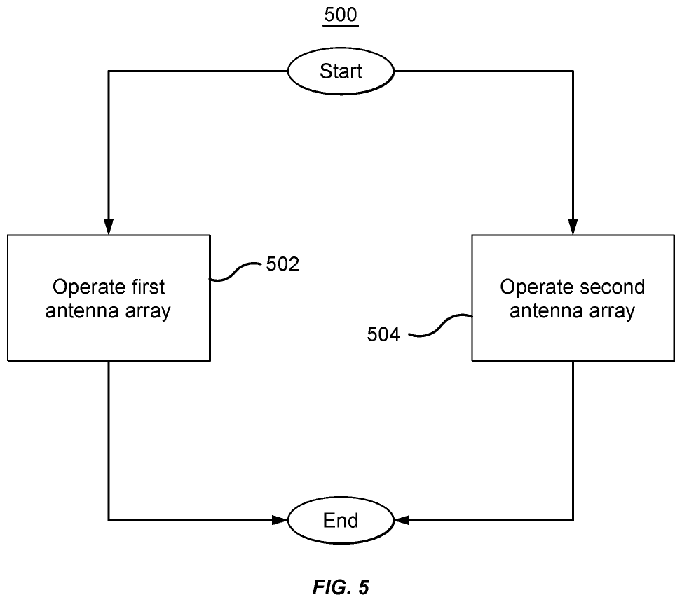

FIG. 5 is a flowchart of an example method 500 performed in the system 100 of FIG. 1. In particular embodiments, the access point 104 performs the method 500. By performing the method 500, the access point 104 operates two radios or antenna arrays concurrently in the same frequency band while maintaining a sufficient amount of isolation between the radios or antenna arrays (e.g., at least 35 dB of isolation).

In block 502, the access point 104 operates a first antenna array. The first antenna array may include multiple antennas that form a radio (e.g., the radio 110A). The antennas are of a first type. For example, the first antenna array may include multiple magnetic loop antennas.

The magnetic loops antennas may be positioned in different quadrants 204 of a plate 202. For example, an antenna 208A may be positioned in a quadrant 204A of the plate 202. An antenna 208B may be positioned in a quadrant 204B of the plate 202. An antenna 208C may be positioned in a quadrant 204C of the plate 202. An antenna 208D may be positioned in a quadrant 204D of the plate 202.

In block 504, the access point 104 may operate a second antenna array. The second antenna array may include multiple antennas that form a second radio (e.g., the radio 110B). The antennas of the second antenna array may be of a different type than the antennas in the first antenna array. For example, the second antenna array may include electric dipole antennas. The electric dipole antennas may be positioned in different quadrants 204 of the plate 202. For example, an antenna 210A may be positioned in the quadrant 204A of the plate 202. An antenna 210B may be positioned in the quadrant 204B of the plate 202. An antenna 210C may be positioned in the quadrant 204C of the plate 202. An antenna 210D may be positioned in the quadrant 204D of the plate 202. The antennas 208A, 208B, 208C and 208D may be positioned closer to the center of the plate 202 than the antennas 210A, 210B, 210C and 210D.

The access point 104 may perform the blocks 502 and 504 simultaneously or concurrently. Stated differently, the access point 104 may operate the first antenna array and the second antenna array concurrently. Additionally, the access point 104 may operate the first antenna array and the second antenna array using the same frequency bands (e.g., the 5 GHz band or the 6 GHz band). Because the first antenna array uses antennas of a different type than the second antenna array, the antennas of the first antenna array may be positioned close to (e.g., within four centimeters) of the antennas of the second antenna array while maintaining a sufficient amount of isolation between the antenna arrays (e.g., at least 35 dB of isolation). For example, because the first antenna array may use magnetic loop antennas and the second antenna array may use electric dipole antennas, the magnetic loop antennas may be positioned within four centimeters of the electric dipole antennas on the plate 202. The access point 104 may then operate the magnetic loop antennas and the electric dipole antennas concurrently using the same frequency band while maintaining a sufficient amount of isolation between the magnetic loop antennas and the electric dipole antennas, despite the fact that the magnetic loop antennas and the electric dipole antennas are positioned close to each other.

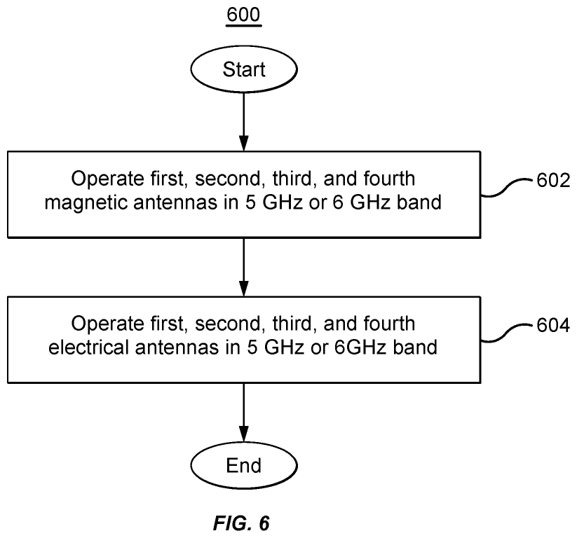

FIG. 6 is a flowchart of an example method 600 performed in the system 100 of FIG. 1. In particular embodiments, the access point 104 performs the method 600. By performing the method 600, the access point 104 operates multiple radios concurrently using the same frequency band while maintaining a sufficient amount of isolation between the radios.

In block 602, the access point 104 operates first, second, third, and fourth magnetic antennas in a 5 GHz band or a 6 GHz band. The magnetic antennas may be magnetic loop antennas. The magnetic antennas may be positioned in different quadrants 204 of a plate 202. In block 604, the access point 104 operates first, second, third, and fourth electrical antennas in the 5 GHz band or the 6 GHz band. The electrical antennas may be electric dipole antennas. The first, second, third, and fourth electrical antennas may be positioned in different quadrants 204 of the plate 202. As a result, each quadrant 204 of the plate 202 may include one of the magnetic antennas, and one of the electrical antennas.

In some embodiments, the access point 104 performs the block 602 and the block 604 concurrently or simultaneously. Stated differently, the access point 104 operates the first, second, third, and fourth magnetic antennas concurrently with the first, second, third, and fourth electrical antennas. Additionally, the access point 104 may operate the magnetic antennas using the same frequency band as the electrical antennas. Moreover, the magnetic antennas and the electrical antennas may be positioned close to each other (e.g., within four centimeters of each other) in their respective quadrants 204 of the plate 202. Because the magnetic antennas and the electrical antennas are different types from each other, the access point 104 may operate the magnetic antennas and the electrical antennas concurrently using the same frequency band, even though the magnetic antennas and the electrical antennas are positioned close to each other. The magnetic antennas and electrical antennas may maintain a sufficient amount of isolation (e.g., at least 35 dB of isolation) while being operated concurrently due to their different antenna types. As a result, the access point 104 may operate multiple radios concurrently in the same frequency band.

In summary, the access point 104 uses radios or antenna arrays with different types of antennas. For example, the access point may include an antenna array that uses magnetic loop antennas and another antenna array that uses electric dipole antennas. These antenna arrays may be positioned close to each other (e.g., within 4 centimeters of each other) and may operate in the same frequency band while maintaining an acceptable level of isolation between the antenna arrays (e.g., more than 35 dB of isolation). As a result, the access point 104 may operate concurrent 5 GHz or 6 GHz radios.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An access point comprising:
a first antenna array comprising a plurality of magnetic antennas; and
a second antenna array comprising a plurality of electrical antennas, wherein each magnetic antenna of the plurality of magnetic antennas is positioned within four centimeters of a respective electrical antenna of the plurality of electrical antennas.

2. The access point of claim 1, wherein the first antenna array and the second antenna array are arranged to operate simultaneously in at least one of a 5 gigaHertz band or a 6 gigaHertz band while providing at least 35 decibels of isolation between the first antenna array and the second antenna array.

3. The access point of claim 1, further comprising a plate, wherein the plurality of magnetic antennas comprises:
a first magnetic antenna positioned in a first quadrant of the plate;
a second magnetic antenna positioned in a second quadrant of the plate;
a third magnetic antenna positioned in a third quadrant of the plate; and
a fourth magnetic antenna positioned in a fourth quadrant of the plate.

4. The access point of claim 3, wherein the plurality of electrical antennas comprises:
a first electrical antenna positioned in the first quadrant;
a second electrical antenna positioned in the second quadrant;
a third electrical antenna positioned in the third quadrant; and
a fourth electrical antenna positioned in the fourth quadrant.

5. The access point of claim 4, wherein the plurality of magnetic antennas are positioned closer to a center of the plate than the plurality of electrical antennas.

6. The access point of claim 4, further comprising:
a first antenna positioned on a center of the plate; and
a second antenna positioned between the first electrical antenna and the second electrical antenna.

7. The access point of claim 1, wherein the plurality of magnetic antennas comprises magnetic loop antennas, and wherein the plurality of electrical antennas comprises electric dipole antennas.

8. A method comprising:
operating a first antenna array of an access point, wherein the first antenna array comprises a plurality of magnetic antennas; and
while operating the first antenna array, operating a second antenna array of the access point, wherein the second antenna array comprises a plurality of electrical antennas, wherein each magnetic antenna of the plurality of magnetic antennas is positioned within four centimeters of a respective electrical antenna of the plurality of electrical antennas.

9. The method of claim 8, wherein operating the first antenna array and the second antenna array comprises operating the first antenna array and the second antenna array in at least one of a 5 gigaHertz band or a 6 gigaHertz band while providing at least 35 decibels of isolation between the first antenna array and the second antenna array.

10. The method of claim 8, wherein the plurality of magnetic antennas comprises:
a first magnetic antenna positioned in a first quadrant of a plate;
a second magnetic antenna positioned in a second quadrant of the plate;
a third magnetic antenna positioned in a third quadrant of the plate; and
a fourth magnetic antenna positioned in a fourth quadrant of the plate.

11. The method of claim 10, wherein the plurality of electrical antennas comprises:
a first electrical antenna positioned in the first quadrant;
a second electrical antenna positioned in the second quadrant;
a third electrical antenna positioned in the third quadrant; and
a fourth electrical antenna positioned in the fourth quadrant.

12. The method of claim 11, wherein the plurality of magnetic antennas are positioned closer to a center of the plate than the plurality of electrical antennas.

13. The method of claim 11, further comprising:
operating a first antenna positioned on a center of the plate; and
operating a second antenna positioned between the first electrical antenna and the second electrical antenna.

14. The method of claim 8, wherein the plurality of magnetic antennas comprises magnetic loop antennas, and wherein the plurality of electrical antennas comprises electric dipole antennas.

15. A system comprising:
a first magnetic loop antenna;
a first electric dipole antenna;
a second magnetic loop antenna; and
a second electric dipole antenna, wherein the first and second magnetic loop antennas and the first and second electric dipole antennas are arranged to operate simultaneously in at least one of a 5 gigaHertz band or a 6 gigaHertz band while providing at least 35 decibels of isolation between the first and second magnetic loop antennas and the first and second electric dipole antennas.

16. The system of claim 15, further comprising:
a third magnetic loop antenna;
a third electric dipole antenna positioned within four centimeters of the third magnetic loop antenna;
a fourth magnetic loop antenna; and
a fourth electric dipole antenna positioned within four centimeters of the fourth magnetic loop antenna.

17. The system of claim 16, further comprising a plate, wherein:
the first magnetic loop antenna is positioned in a first quadrant of the plate;
the second magnetic loop antenna is positioned in a second quadrant of the plate;
the third magnetic loop antenna is positioned in a third quadrant of the plate; and
the fourth magnetic loop antenna is positioned in a fourth quadrant of the plate.

18. The system of claim 17, wherein:
the first electric dipole antenna in positioned in the first quadrant;
the second electric dipole antenna is positioned in the second quadrant;
the third electric dipole antenna is positioned in the third quadrant; and
the fourth electric dipole antenna is positioned in the fourth quadrant.

19. The system of claim 18, wherein the first electric dipole antenna is positioned closer to a center of the plate than the first magnetic loop antenna.

20. The system of claim 18, further comprising:
a first antenna positioned on a center of the plate; and
a second antenna positioned between the first electric dipole antenna and the second electric dipole antenna.
